(19) United States
(12) Patent Application Publication
(10) Pub. No.: US 2021/0176539 A1
(43) Pub. Date: Jun. 10, 2021

(54) INFORMATION PROCESSING DEVICE, INFORMATION PROCESSING SYSTEM, INFORMATION PROCESSING METHOD, AND PROGRAM

(71) Applicant: SONY CORPORATION, TOKYO (JP)

(72) Inventors: YOSHINORI KURATA, TOKYO (JP); MANABU KII, TOKYO (JP); KAZUMA TAKAHASHI, TOKYO (JP)

(21) Appl. No.: 17/250,616

(22) PCT Filed: Jun. 11, 2019
(86) PCT No.: PCT/JP2019/023004

§ 371 Date: Feb. 11, 2021

(30) Foreign Application Priority Data
Aug. 21, 2018 (JP) 2018-154623

(51) Int. Cl. H04N 21/854; G06F 40/279; H04N 21/235; H04N 21/234

(52) U.S. Cl. CPC H04N 21/854; H04N 21/23424; H04N 21/235; G06F 40/279

(57) ABSTRACT

An information processing device includes a control unit configured to acquire material data including sentence data including a control character, analyze the material data, perform output based on the sentence data, and automatically generate program content data on which control based on the control character is reflected.

### TECHNICAL FIELD

The present disclosure relates to an information processing device, an information processing system, an information processing method, and a program.

### BACKGROUND ART

In recent years, with the progress of information processing technology, various methods of generating or providing program content to be broadcasted on television, radio, Internet moving image distribution sites, or the like have been developed. For example, Patent Document 1 below discloses a technique for generating program content by combining various text information items to be provided on a website, such as news, weather, and Twitter feed, with audio data such as music, and a technique for outputting the generated program content by voice.

### CITATION LIST

### Patent Document

Patent Document 1: Japanese Patent No. 6065019

### SUMMARY OF THE INVENTION

### Problems to be Solved by the Invention

In such a field, it is desired that, for example, even a user who has no specialized knowledge can easily perform creation, editing, and the like on program content.

One object of the present disclosure is to provide an information processing device, an information processing system, an information processing method, and a program that allow a user who has no specialized knowledge to easily perform creation, editing, and the like on program content.

### Solutions to Problems

The present disclosure is, for example,

an information processing device including

a control unit configured to acquire material data including sentence data including a control character, analyze the material data, perform output based on the sentence data, and automatically generate program content data on which control based on the control character is reflected.

The present disclosure is, for example,

an information processing system including:

a communication unit configured to receive message information including sentence data including a control character, the message information being transmitted from an arbitrary terminal; and

a control unit configured to analyze the sentence data, perform output based on the sentence data, and automatically generate program content data on which control based on the control character is reflected in a case where account information of the received message information is account information set in advance.

The present disclosure is, for example,

an information processing method including, by a control unit:

acquiring material data including sentence data including a control character, analyzing the material data, performing output based on the sentence data, and automatically generating program content data on which control based on the control character is reflected.

The present disclosure is, for example,

a program for causing a computer to execute an information processing method including, by a control unit:

acquiring material data including sentence data including a control character, analyzing the material data, performing output based on the sentence data, and automatically generating program content data on which control based on the control character is reflected.

### Effects of the Invention

According to at least one embodiment, the program content can be easily created, edited, and the like. Note that advantageous effects described here are not necessarily restrictive, and any of the effects described in the present disclosure may be applied. Furthermore, the contents of the present disclosure are not limitedly interpreted by the illustrated effect.

### BRIEF DESCRIPTION OF DRAWINGS

FIG. 1 is a diagram showing a configuration of a program provision system according to embodiments of the present disclosure.

FIG. 2 is a diagram showing one example of “genre”, which is information input by a creator of program content.

FIG. 3 is a diagram showing one example of “type”, which is information input by the creator of the program content.

FIGS. 4A to 4C are views showing one example of “template”, which is information input by the creator of program content.

FIG. 5 is a diagram showing one example of a plurality of manuscript data in a case where the plurality of manuscript data with different playback times are generated for certain transmitted information.

FIGS. 6A and 6B are views for describing a function of adapting visual information to information to be transmitted, playback date and time, or the like.

FIG. 7 is a view for describing a function of automatically adding an operation of a character.

FIG. 8 is a block diagram showing one example of a functional configuration provided in a distribution device.

FIG. 9 is a block diagram showing one example of a functional configuration provided in a user terminal.

FIG. 10 is a flowchart showing one example of an operation of the distribution device.

FIG. 11 is a flowchart showing one example of an operation of the user terminal.

FIG. 12 is a block diagram showing one example of a hardware configuration of the distribution device and the user terminal.

FIG. 13 is a view showing one example of a setting screen for making various settings for automatically generating program content data.

FIG. 14 is a view showing a screen example of a mail created by the user terminal.

FIGS. 15A and 15B are diagrams showing one example of images attached to the mail.

FIG. 16 is a flowchart for describing an operation example to be performed by a distribution device in a second embodiment.

FIGS. 17A and 17B are diagrams for describing specific examples of automatically generated program content.

### MODE FOR CARRYING OUT THE INVENTION

Preferred embodiments of the present disclosure will be described in detail below with reference to the accompanying drawings. Note that in the present specification and the drawings, components having substantially the same functional configuration are denoted with the same reference symbol, and redundant description thereof will be omitted as needed.

Note that the description will be made in the following order.

<First embodiment>

<Second embodiment>

<Modification>

### First Embodiment

[Background]

To begin with, a background of the present disclosure will be described. Program content broadcasted on television, radio, moving image distribution sites on the Internet, or the like includes a manuscript created in advance, an ad-lib of a speaker (for example, announcer, moderator, radio personality, or the like), and the like.

More specifically, the speaker adjusts program content to finish within a broadcast time determined in advance by performing addition, change, deletion, or the like on contents to transmit on the basis of the speaker's own skill, experience, and the like. For example, in a case where contents of the manuscript is larger than can be transmitted in a remaining broadcast time, the speaker adjusts the program content to finish within the broadcast time while transmitting higher-priority information by omitting lower-priority contents, making a change into a shorter expression, and the like.

Furthermore, in a case where there is a plurality of manuscripts, the speaker smoothly transitions from one manuscript to the next manuscript by inserting a conjunction (for example, “Well”, “Next”, “Then”, “By the way”, and the like), ad-lib, or the like as appropriate in a period after finishing reading one manuscript and until starting reading the next manuscript.

Furthermore, the speaker may add an ad-lib depending on a viewing situation of users. For example, in a case where information transmitted in the past is transmitted again, the speaker may add an ad-lib as an introductory part to the manuscript contents, such as “As explained.”

Furthermore, in a case where new information that has not been transmitted in the past is transmitted, the speaker may add an ad-lib such as “New information has arrived about.”

Furthermore, in a case where it becomes necessary to transmit emergency information (disaster information, other important information, and the like), the speaker preferentially transmits the emergency information by transmitting the emergency information in the middle of the information being transmitted, or by changing the order of the information to transmit.

Furthermore, the speaker may transmit information with gestures such as gesticulating with body and hands according to contents of the information to transmit. For example, in a weather forecast, the speaker may transmit information while pointing at a part of a weather map with a pointer, or may transmit information while looking at a displayed moving image or still image.

Furthermore, the speaker appropriately changes facial expression, voice tone, or the like on the basis of contents to transmit. For example, in a case where contents to transmit are sad news (for example, occurrence of accident or disaster, death of a person, or the like), the speaker transmits information by changing the facial expression darkly and changing the voice tone low. Conversely, in a case where contents to transmit are good news (for example, marriage, childbirth, victory in a tournament, or the like), the speaker transmits information by changing the facial expression brightly and changing the voice tone high. Furthermore, in addition to the facial expression or voice tone, for example, the speaker's costume, BGM, background, or the like may be changed on the basis of the contents to transmit.

Furthermore, BGM, background, speaker's facial expression, voice tone, costume, or the like may be changed on the basis of not only transmitted contents, but also the date and time or region where the program content is played back, season, weather, or temperature at the time of playback. For example, in a case where the season at the time of playback is summer, the speaker's costume may be changed to summer clothes, and BGM and background may be changed to a piece of music and background reminiscent of summer.

On the basis of the above, a lot of work is done before one program content is created, including manuscript creation, costume determination and procurement, BGM determination and editing, determination, creation, and installation of the background, camerawork determination, casting of the speaker, meeting with the speaker, examination of ad-lib contents by the speaker and the like, rehearsal, actual image capturing, editing, broadcasting, and the like. With the work, the cost of creating program content tends to increase. Furthermore, quality of the program content (whether or not a viewer is comfortable to view, whether or not the ad-lib is appropriate, and the like), whether or not the program content finishes within the broadcast time, and the like depend on skill, experience, or the like of the speaker.

The person who has disclosed the present disclosure has created the present disclosure in view of the above circumstances. The present disclosure can acquire material data, analyze contents of the material data, and automatically generate program content including visual information on the basis of the contents. Hereinafter, details of the program provision system according to the embodiment of the present disclosure will be described.

[Configuration of Program Provision System]

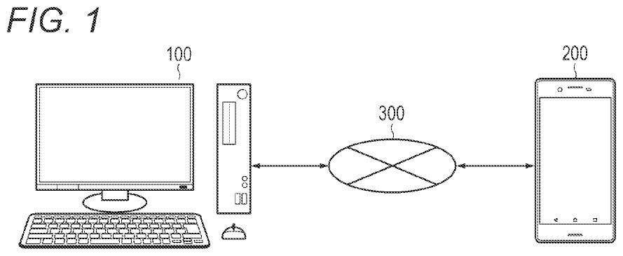

The background of the present disclosure has been described above. Subsequently, with reference to FIG. 1, a configuration of the program provision system according to the embodiment of the present disclosure will be described.

As shown in FIG. 1, the program provision system according to the present embodiment includes a distribution device 100 and a user terminal 200. The distribution device 100 and the user terminal 200 are connected by a network 300.

The distribution device 100 is an information processing device having a function of automatically generating and distributing program content. More specifically, if a creator of program content inputs material data that is a source of the program content to the distribution device 100, the distribution device 100 automatically generates the program content including visual information on the basis of contents of the material data.

For example, the distribution device 100 generates manuscript data on the basis of sentence data input as material data. Then, the distribution device 100 generates program content including visual information on the basis of the manuscript data, and moving image data, still image data, or the like input as material data. Here, the program content may be able to output voice by applying speech synthesis processing on the manuscript data, may be able to display the manuscript data as subtitles, or may be able to display, for example, an arbitrary character other than the input moving image data or still image data. Furthermore, the program content includes, but is not limited to, content to be broadcasted on television, content to be distributed on a moving image distribution site on the Internet, content to be displayed on a predetermined advertising medium, content to be broadcasted on radio, or the like. Details of contents and a generation method of the program content and the like will be described later.

Then, the distribution device 100 provides the program content to the viewer by providing the generated program content to the user terminal 200. More specifically, the distribution device 100 uploads program content to a server (for example, world wide web (WEB) server that manages a specific WEB site on the Internet, and the like) accessible to the user terminal 200, and the user terminal 200 downloads the program content from the server. Note that the method of providing the program content is not limited to this method. For example, the user terminal 200 may directly access the distribution device 100 via the network 300 to acquire the program content. Furthermore, push-type distribution may be performed instead of pull-type distribution in which the user terminal 200 downloads the program content.

The user terminal 200 is an information processing device having a function of playing back the program content distributed by the distribution device 100. More specifically, the user terminal 200 plays back the program content selected on the basis of an operation by the viewer by using an output unit provided in the own device (for example, display, speaker, and the like).

Furthermore, the user terminal 200 has a function of editing the program content generated by the distribution device 100. For example, the user terminal 200 has a function of editing contents of the program content (manuscript data, moving image data, still image data, BGM contents, or the like) or the playback method (for example, display size, sound volume, speed, and the like) on the basis of setting by the viewer, preference information on the viewer, or the like. Furthermore, the user terminal 200 also has a function of generating the program content by using the material data processed by the distribution device 100 halfway. For example, the user terminal 200 has a function of generating the program content by using the material data to which the distribution device 100 applies noise removal by filtering, trimming, format conversion, and the like.

Note that as one example, the present specification describes a case where the user terminal 200 plays back or edits the program content generated by the distribution device 100 as described above, but various processes may be performed by either the distribution device 100 or the user terminal 200 (in other words, the distribution device 100 and the user terminal 200 can have the same functional configuration as each other.) For example, the distribution device 100 may distribute data that is a source of the program content (material data itself or data obtained by processing the material data), and the user terminal 200 may automatically generate and play back the program content by using the data, preference information on the viewer, and the like. Furthermore, the user terminal 200 may provide the preference information on the viewer and the like to the distribution device 100, and the distribution device 100 may distribute the program content automatically generated by using the information to the user terminal 200.

The distribution device 100 and the user terminal 200 are each, but not limited to, for example, a personal computer (PC) of a desktop type, notebook type, or a tablet type, a smartphone, a general-purpose computer, a wearable terminal of various types (for example, glasses-type terminal, watch-type terminal, clothing-type terminal, ring-type terminal, bracelet-type terminal, earring-type terminal, necklace-type terminal, and the like), a head-mounted display, and the like.

The network 300 is a wired or wireless transmission line for information communicated by the distribution device 100 and the user terminal 200 connected to the network 300. For example, the network 300 may include a public line network such as the Internet, various local area networks (LANs) including Ethernet (registered trademark), a wide area network (WAN), and the like. Furthermore, the network 300 may include a dedicated line network such as an Internet protocol-virtual private network (IP-VPN), a near field communication network such as Bluetooth (registered trademark), and the like.

Note that the configuration of FIG. 1 is just one example, and the configuration of the program provision system according to the present embodiment is not limited to this example. For example, as described above, the program provision system according to the present embodiment may include either the distribution device 100 or the user terminal 200.

[Functional Outline]

The configuration of the program provision system according to the embodiment of the present disclosure has been described above. Subsequently, the functional outline of the program provision system according to the embodiment will be described.

(Manuscript Generating Function)

The program provision system according to the present embodiment has a function of automatically generating the manuscript data to be broadcasted.

More specifically, to begin with, sentence data as material data, and a genre or type of contents of the sentence data, or information regarding a template are input into the distribution device 100.

Here, the sentence data is assumed to be a text file or a data file generated by word processing software and the like, but is not limited to this example. For example, the sentence data may be an image file in which sentences are displayed, and the sentences may be extracted by the distribution device 100 analyzing the image file. Furthermore, the sentence data may be singular data or a plurality of data.

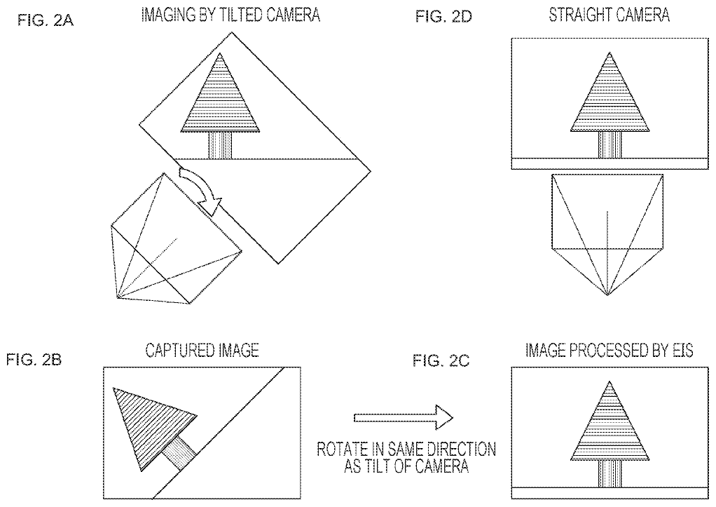

Furthermore, the genre of the contents of sentence data is a classification of information to be transmitted, and is, for example, as shown in FIG. 2, “politics”, “economy”, “entertainment”, “sports”, “international”, “weather”, and the like, but is not limited to this example. For example, the genre may be a subdivision of the genre described above (for example, “weather” and the like), such as “nationwide weather”, “Tokyo weather”, “weekly weather”, “daily weather”, and the like. Note that input of the genre is not mandatory.

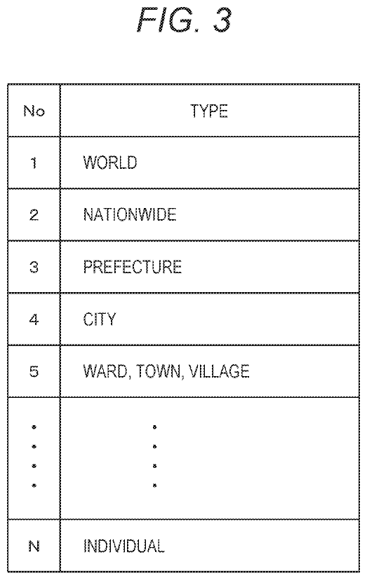

Furthermore, the type of contents of sentence data is a distinction of information to be transmitted by some kind. For example, as shown in FIG. 3, the type is a distinction by the kind of information transmission target range such as “world”, “nationwide”, “prefecture”, “city”, “ward, town, village”, “individual”, and the like, but is not limited to this example. For example, the type of contents of sentence data may be a distinction according to the kind of person to whom information is transmitted, such as “male”, “female”, “senior citizen”, “child”, and the like, or may be a distinction according to the kind of urgency of information transmission, such as “urgent”, “normal”, or the like, or may be a distinction according to information contents such as “sad news”, “good news”, or the like. Note that input of the type is not mandatory.

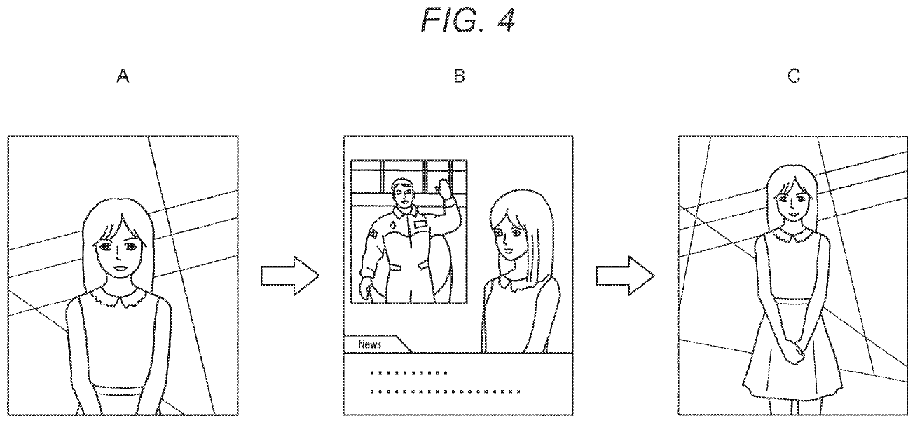

The template is information indicating a configuration pattern of the program content. For example, the template is a configuration pattern of “opening (4A)”, “topic (4B)”, and “ending (4C)” as shown in FIG. 4. Note that the template may not be limited to the example of FIG. 4, and may be, for example, a configuration pattern in which any of “opening (4A)”, “topic (4B)”, and “ending (4C)” is omitted, or may be a configuration pattern to which configurations other than these are added. Furthermore, the template may be information to which settings such as camera work, screen configuration (character, moving image, still image, or positional relationship of telop, or the like), presence or absence of a character, character attribute (gender, age, voice quality, costume, type of character in a case where the character is non-human (animal and the like)), presence or absence of voice, and the like are added. The template may be created by the creator, or may be automatically generated on the basis of learning results of existing programs (for example, television program, Internet distribution program, radio program, and the like). The creator can cause the distribution device 100 to generate desired program content by selecting such a template. Note that input of the template is not mandatory.

The distribution device 100 automatically generates the manuscript data on the basis of the input various information items described above. More specifically, the distribution device 100 analyzes the input sentence data and determines contents of the sentence data. For example, the distribution device 100 extracts a word included in the sentence data, and recognizes contents of the word by using information stored in the own device, information acquired from an external device (for example, external WEB server and the like), or the like. With this configuration, the distribution device 100 can recognize not only the input genre or type but also the genre, type, or the like of the contents of the sentence data on the basis of a result of analyzing the sentence data by itself for use in subsequent processing.

Then, the distribution device 100 automatically generates the manuscript data to be broadcasted on the basis of the analysis result of the genre, type, template, sentence data, and the like. More specifically, the distribution device 100 automatically generates the manuscript data by performing deletion or change of a part of the input sentence data, addition of information that is not included in the sentence data, or the like.

Here, automatic generation of manuscript data will be described by taking the case where the template of FIG. 4 is used as one example. For example, it is assumed that sentence data about information to be broadcasted in the topic (4B) is input into the distribution device 100. By using the input sentence data, the distribution device 100 automatically generates the manuscript data to be broadcasted in the topic (4B), and automatically generates the manuscript data to be broadcasted in the opening (4A) and the ending (4C) as well.

When generating the manuscript data to be broadcasted in the opening (4A), the topic (4B), and the ending (4C), the distribution device 100 adds contents that is not included in the input sentence data on the basis of contents of information to be transmitted, the date and time or region where the program content data is played back, or the season, weather, or temperature at the time of playback. For example, the distribution device 100 may add contents based on the date and time when the program content data is played back in the opening (4A), such as “Happy new year. We will bring you the news of Jan. 1, 2017.”

Furthermore, the distribution device 100 may add contents based on contents of information to be transmitted at the beginning of the topic (4B), such as “As the first thing, sad news has come in.”

Furthermore, the distribution device 100 may add contents based on the region of playback and the weather at the time of playback in the ending (4C), such as “After this, it is expected that it will rain heavily in Tokyo from 10 am to 15 pm. Make sure to carry your rain gear.”

Furthermore, contents may be added according to behavior of the viewer, a situation (or environment) in which the viewer is placed, or the like. More specifically, by analyzing data acquired by various sensors of a wearable terminal worn by the viewer (for example, acceleration sensor, gyro sensor, barometric sensor, or the like), the distribution device 100 (or user terminal 200) may recognize the behavior of the viewer, the situation in which the viewer is placed, or the like and may add contents corresponding thereto. For example, in a case where it is recognized that the viewer is traveling to work, the distribution device 100 and the like may add contents such as “Do your best in your work today” to the ending (4C).

Furthermore, the distribution device 100 and the like may predict the behavior of the viewer, the situation (or environment) in which the viewer is placed at a certain time point in the future, or the like by analyzing the sensing data described above and the like, and add contents according to the prediction result. For example, in a case where it is recognized that the viewer is in a vehicle (for example, train, car, or the like) while traveling to work, the distribution device 100 and the like may add contents such as “Do your best in your work today” at getting-off time predicted on the basis of the past behavior history. Note that the contents to be added as described above may be automatically generated by inputting other sentence data in advance.

Furthermore, the distribution device 100 deletes or changes a part of the input sentence data. For example, in a case where contents added as described above include contents that overlaps with the input sentence data (for example, in a case where the contents “We will bring you the news of Jan. 1, 2017” are added and contents with similar meaning are included in the sentence data), the distribution device 100 may appropriately delete or change the overlapping portion in the sentence data. Furthermore, in a case where the same word appears frequently or a difficult word exists, the distribution device 100 may change the word to another expression as appropriate.

Note that the distribution device 100 may generate the manuscript data without changing the sentence data, which is material data. For example, in a case where changing the sentence data is prohibited for some reason (for example, in a case where the sentence data is copyrighted and the like), the distribution device 100 may generate the manuscript data by adjusting contents to add before and after the sentence data without changing the input sentence data. At that time, the distribution device 100 can make the viewer less likely to feel uncomfortable by adjusting a reading speed of the manuscript or by providing an appropriate interval (note that adjustment of the playback time will be described later).

This allows the distribution device 100 to generate high-quality program content the speaker (for example, announcer, moderator, radio personality, or the like) provides with an ad-lib, and can reduce costs of generating the program content. Furthermore, the creator of the program content can focus on creating the sentence data, which is core information.

Furthermore, in program content of which the broadcast time is determined in advance, the distribution device 100 can generate manuscript data such that the program content finishes within the broadcast time. More specifically, the distribution device 100 calculates playback time of voice data when generating the manuscript data. For example, the distribution device 100 calculates the playback time of voice data after speech synthesis of the manuscript data on the basis of contents of various parameters to be used for speech synthesis.

Then, in a case where the playback time of the generated manuscript data (or manuscript data being generated) is longer than the broadcast time determined in advance, the distribution device 100 edits the manuscript data. For example, the distribution device 100 edits the manuscript data such that the playback time of the manuscript data becomes the broadcast time determined in advance by deleting low-priority information in the input sentence data, making a change into expression different from the sentence data, deleting or changing the added contents, and the like. Conversely, in a case where the playback time of the generated manuscript data (or manuscript data being generated) is shorter than the broadcast time determined in advance, the distribution device 100 edits the manuscript data such that the playback time of the manuscript data becomes the broadcast time determined in advance by making a change into expression different from the input sentence data, changing the added contents, newly adding another contents, and the like.

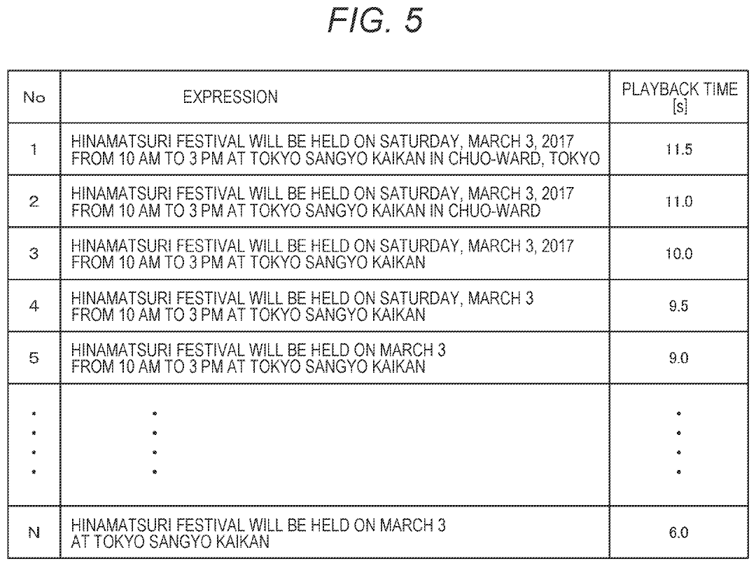

Here, the distribution device 100 may implement generation of the manuscript data that finishes within the broadcast time by generating a plurality of manuscript data with different playback times for certain transmitted information and selecting appropriate manuscript data from among the plurality of manuscript data. For example, the distribution device 100 analyzes the input sentence data, and on the basis of the analysis result, generates a plurality of manuscript data that has different playback times and can be understood by the viewer, as shown in FIG. 5. Then, the distribution device 100 may implement generation of the manuscript data that finishes within the broadcast time by selecting appropriate manuscript data from among the plurality of manuscript data on the basis of the broadcast time, manuscript data of other transmitted information, or the like. Note that the distribution device 100 may allow the creator to select desired manuscript data from among the plurality of manuscript data by presenting the creator with a list as shown in FIG. 5.

As described above, the distribution device 100 can operate such that the speaker (for example, announcer, moderator, radio personality, or the like) changes contents to transmit, expression method, speaking speed, and the like on the basis of information to transmit and remaining broadcast time, and can finish the program content within the broadcast time.

(Function of Generating Sound or Visual Information)

Furthermore, the program provision system according to the present embodiment has a function of automatically generating sound or visual information of the program content.

More specifically, moving image data, still image data, or the like is input into the distribution device 100 as material data. Then, by using the data, information set as described above (genre, type, template, or the like), and the manuscript data generated as described above, the distribution device 100 automatically generates program content including sound or visual information.

For example, the distribution device 100 generates program content including voice data by performing speech synthesis processing using the generated manuscript data. Furthermore, the distribution device 100 can add not only voice but also some sound (for example, BGM, sound effect, and the like). Furthermore, the distribution device 100 may add some sound on the basis of the analysis result of input material data. For example, in a case where it is analyzed that the material data is moving image data regarding a sports event and the like, the distribution device 100 may add a theme song of the sports event as BGM.

Furthermore, on the basis of the set template, the distribution device 100 determines a configuration pattern of the program content (including information with added setting such as camera work, screen configuration (character, moving image, still image, positional relationship of telop, and the like), presence or absence of the character, character attribute (gender, age, voice quality, costume, type of character in a case where the character is non-human (animal and the like)), presence or absence of voice, and the like). Then, the distribution device 100 inserts the input moving image data or still image data into predetermined timing and position in the configuration pattern. More specifically with reference to FIG. 4, the distribution device 100 inserts the input moving image data or still image data at the upper left position of the screen in the topic (4B).

At this time, the distribution device 100 may appropriately edit the input moving image data or still image data. More specifically, the distribution device 100 analyzes the moving image data or still image data, and recognizes a more important part in the moving image data or still image data. Note that the distribution device 100 may refer to the contents of the manuscript data when analyzing the moving image data or still image data. For example, in a case where a word “astronaut” exists in the manuscript data, the distribution device 100 may recognize that the astronaut included in the moving image data or still image data has higher importance. Then, the distribution device 100 may allow the moving image data or still image data to be more appropriately inserted into the screen by editing the moving image data or still image data such that the more important part can be visually recognized easily (for example, trimming, changing the aspect ratio, and the like).

This allows the distribution device 100 to reduce production costs of the program content including sound or visual information while maintaining high quality of the program content.

Note that a method of generating the character displayed in the program content is not particularly limited, and arbitrary technique for generating a two-dimensional animation can be used. For example, a technique to generate a two-dimensional animation by designating a plurality of feature points in an illustration generated by arbitrary software and designating the temporal change of position coordinates of each feature point may be used. Furthermore, a three-dimensional animation may be generated by using an arbitrary three-dimensional modeling technique together (for example, modeling, rendering, retouching, or the like).

(Function of Adapting Sound or Visual Information to Information to be Transmitted, Playback Date and Time, or the Like)

Furthermore, the program provision system according to the present embodiment has a function of adapting sound or visual information to contents of information to be transmitted, the playback date and time, or the like.

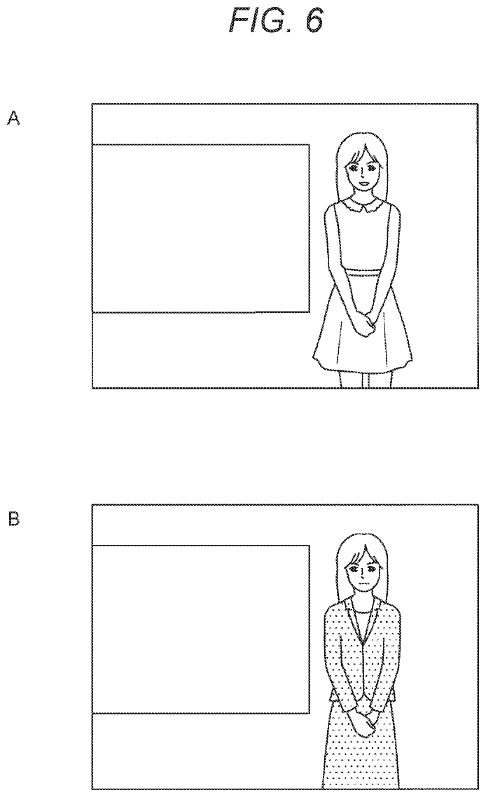

More specifically, the distribution device 100 recognizes the contents of the information to be transmitted by an analysis result of the information to be transmitted or the set information (genre, type, template, or the like), and adapts the sound or visual information of the program content to the contents. For example, in a case where the contents of information to be transmitted is about good news, as shown in FIG. 6A, the distribution device 100 determines a costume that gives a bright impression to the viewer as the character costume. Conversely, in a case where the contents of information to be transmitted is about sad news, as shown in FIG. 6B, the distribution device 100 determines a costume that gives a dark impression (or formal impression) to the viewer as the character costume. Of course, the specific contents of the costume is not limited to FIG. 6. For example, if the contents of information to be transmitted is about a sports event, the character costume may be a uniform of a sports team and the like.

Note that the distribution device 100 can adapt not only the character costume but also BGM, background, attribute, facial expression, voice tone, or the like of the character. For example, in the distribution device 100, in a case where the information to be transmitted is good news, the distribution device 100 may use a song, background, and character that give a bright impression as the BGM, background, and character, and make the facial expression of the character bright, and raise the voice tone of the character.

Furthermore, the distribution device 100 adapts sound or visual information to the date and time or region where the program content data is played back, or the season, weather, temperature, or the like at the time of playback. For example, in a case where the season of broadcasting is summer, the distribution device 100 may use a song and background reminiscent of summer as the BGM and background, use summer clothes as the character's costume, and have the character's skin tanned. Note that the above description is just one example, and the distribution device 100 may control sound or visual information on the basis of information other than the date and time or region where the program content data is played back, or the season, weather, or temperature at the time of playback.

Furthermore, the distribution device 100 adapts sound or visual information to the behavior of the viewer, the situation (or environment) in which the viewer is placed, or the like. More specifically, the distribution device 100 recognizes the behavior of the viewer, the situation in which the viewer is placed, and the like by analyzing data acquired by various sensors of a wearable terminal worn by the viewer (for example, acceleration sensor, gyro sensor, barometric sensor, or the like), and adapts sound or visual information thereto. For example, in a case where the distribution device 100 recognizes that the viewer is spending a holiday in a relaxed state, the distribution device 100 may use a song and background having a high relaxation effect as the BGM and background, and use a more casual costume as the character costume. Furthermore, the distribution device 100 may predict, for example, the behavior of the viewer or the situation (or environment) in which the viewer is placed at a certain time point in the future by analyzing the sensing data described above and the like, and may adapt sound or visual information to the prediction result.

Furthermore, a target to be controlled in the above description is not limited to BGM, background, character attribute, costume, facial expression, or voice tone. Anything regarding the sound or visual information of the program content will do.

This allows the distribution device 100 to produce effects similar to effects of the speaker (for example, announcer, moderator, radio personality, or the like) changing the facial expression and voice tone, or changing the speaker's costume, BGM, background, or the like on the basis of the contents of transmitted information, the playback date and time, or the like.

(Function of Adding Character Operation)

Furthermore, the program provision system according to the present embodiment has a function of automatically adding an operation of the character.

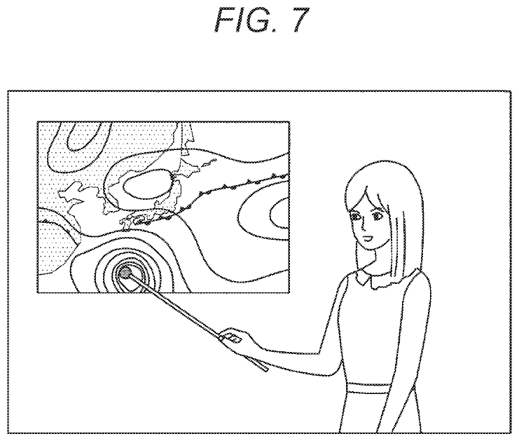

More specifically, the distribution device 100 analyzes the input moving image data or still image data, and controls the operation of the character in conjunction with a display position of the target included in the moving image data or still image data. For example, as shown in FIG. 7, in a case where moving image data regarding transition of the weather map is input, the distribution device 100 analyzes the moving image data and recognizes the display position of a typhoon eye displayed on the weather map. Then, the distribution device 100 may operate the character's hand in conjunction with the transition of the weather map such that the tip of the pointer is located at the display position of the typhoon eye.

Of course, contents of controlling the operation is not limited to the example of FIG. 7. For example, in a case where moving image data of sports is input, the distribution device 100 may cause the character to take a rejoicing reaction at timing when a highlight scene is played back. Furthermore, the target with which the character operates in conjunction is not particularly limited. For example, the target with which the character operates in conjunction may be a person, animal, object, light (for example, firework, illumination, or the like), illustration, character, or the like included in the moving image data or still image data.

This allows the distribution device 100 to produce effects similar to effects of the speaker (for example, announcer, moderator, radio personality, or the like) actually operating in response to the moving image or still image.

(Function of requesting various information items) Furthermore, the program provision system according to the present embodiment has a function of requesting information used for automatically generating the program content.

More specifically, in a case where various information items used to automatically generate the program content described above (for example, genre, type, template, sentence data, moving image data, still image data, or the like) are insufficient, or in a case where the information is inappropriate (in a case where the moving image or still image is not clear, or in a case where the moving image is too short or too long, and the like), and the like, the distribution device 100 can request the creator for insufficient information or new, higher-quality information.

Here, the method of requesting the insufficient information and the like is not particularly limited. For example, the distribution device 100 may use an output unit provided in its own device (for example, display, speaker, or the like) to request the insufficient information and the like. At that time, the distribution device 100 may make a clearer request to the creator by not only just notifying information that “information is insufficient” or “information is inappropriate”, but also by clearly indicating contents of the insufficient information or contents of appropriate information.

This allows the distribution device 100 to automatically generate the program content more smoothly. Furthermore, the distribution device 100 can automatically generate the program content by using more appropriate information, and thus can improve the quality of the program content.

(Function of Generating (Editing) Manuscript According to Playback Situation)

Furthermore, the program provision system according to the present embodiment has a function of automatically generating (or a function of automatically editing) the manuscript data according to the playback situation of the program content by the user.

More specifically, the user terminal 200 determines the playback situation of the program content by the viewer. For example, the user terminal 200 determines contents of information transmitted to the user in the program content that has already been played back entirely, contents of information transmitted to the viewer in a played part of the program content being played back, or the like.

Then, in a case where contents of information to be transmitted in the program content after that is the same as or similar to the information already transmitted, by automatically editing the manuscript data, the user terminal 200 can add a comment such as, for example, “As explained” to the manuscript data. Furthermore, in a case where the contents of information to be transmitted in the program content after that is information that has not yet been transmitted, by automatically editing the manuscript data, the user terminal 200 may add a comment such as, for example, “New information has arrived about” to the manuscript data. Note that contents of editing the manuscript data is not limited thereto.

Furthermore, not only the user terminal 200 but also the distribution device 100 may implement the function. For example, in a case where information of the same or similar contents is transmitted a plurality of times in certain program content, the distribution device 100 may add a comment such as, for example, “As explained” to the manuscript data when automatically generating the manuscript data.

This allows the program provision system to produce effects similar to effects of the speaker (for example, announcer, moderator, radio personality, or the like) appropriately adding an ad-lib according to an information transmission situation.

(Function of Inserting Information on Other Contents)

Furthermore, the program provision system according to the present embodiment has a function of inserting information on another contents (or another program content) into program content being played back (or program content to be played back).

More specifically, the program provision system can set a position where information on other contents can be inserted into the manuscript data (hereafter referred to as “insertable position”). Here, examples of the insertable position include an end position of the program content, a position where the contents of the program content is partitioned (for example, position where a topic changes and the like), a position of a period, or the like, but are not limited thereto.

Then, for example, in a case where emergency information (for example, disaster information, other important information, and the like) is distributed while the user terminal 200 is playing back the program content, the user terminal 200 can insert the emergency information at the insertable position of the program content being played back. At this time, a comment such as “Although in the middle of the program, emergency information will be reported” may be added to the beginning of the emergency information as appropriate. Note that the above description is just one example, and information to be inserted is not limited to emergency information.

Furthermore, in a case where information on other contents is inserted, the information on other contents may be transmitted in the program content being played back (for example, in a case where emergency information is transmitted without changing the character of the program content being played back, and the like), and the information on other contents may be transmitted by switching the program content being played back to another program content.

Note that contents of the program content to be played back after the inserted information on other contents (in other words, unplayed part of the program content being played back before the insertion) can be edited as appropriate. For example, the program content to be played back after the inserted information on other contents may be edited so as to be played back from the position at which the contents are partitioned (for example, the position where a topic changes, and the like). Furthermore, a comment such as “Until now, we have reported the emergency information. Now, we will return to the original program” may be added as appropriate to the beginning of the program content to be played back after the inserted information on other contents. Furthermore, after the information on other contents is inserted, another new program content may be played back instead of the original program content being played back.

Note that in a case where emergency information and the like is simply displayed in part of the display along with sounding of an alarm (that is, in a case where emergency information and the like is not transmitted by voice of a character), insertion into the manuscript data as described above is not necessary, for example.

This allows the program provision system to insert the information on other contents into the program content being played back without giving feeling of uncomfortableness to the viewer.

(Function of Providing Unplayed Program Content)

Furthermore, the program provision system according to the present embodiment has a function of providing unplayed program content to the viewer.

For example, as described above, in a case where there is a part that is not played back in the program content by insertion of emergency information into the middle of the program content and the like, the program provision system can provide the viewer with the unplayed part (or entire program content including the unplayed part). Note that in a case where the program content is not played back at all for some reason, other than insertion of emergency information and the like, the function may be used.

Here, the method of providing the unplayed program content is not particularly limited. For example, the unplayed program content may be provided to a predetermined application (for example, predetermined application installed in the user terminal 200, my page in a predetermined website, or the like). Furthermore, program content including sound or visual information may be provided, but only text files (for example, only text files for topic parts and the like) may be provided. Furthermore, the viewer may be able to designate the provision method by a predetermined method.

This allows the program provision system to provide the viewer with the program content that the viewer has failed to play back for some reason, and to improve the convenience of the viewer.

(Function of Editing Program Content and the Like Associated with Skip and the Like)

Furthermore, the program provision system according to the present embodiment has a function of editing the program content and the like associated with skip and the like.

More specifically, the viewer can skip contents of the program content, commercials, or the like in the middle of viewing the program content (or fast forward, double-speed playback, and the like).

For example, in a case where the broadcast time is determined in advance and one or more pieces of program content are played back so as to finish within the broadcast time, the program content finishes earlier than the broadcast time by the skip described above and the like.

In a case where the playback time of originally planned program content is shortened by the skip and the like, this function can prevent the program content from finishing earlier than the broadcast time by automatically adding another program content that has not been scheduled to be played back, and the like.

Note that timing at which the other program content is added is not particularly limited. For example, the other program content may be added at the last timing of the program content that has been originally planned to be played back, or may be added at timing in the middle of a plurality of pieces of program content.

Furthermore, instead of adding another program content, an unplayed part of the program content being played back or another program content scheduled to be played back may be automatically edited. For example, the playback time of the unplayed part of the program content being played back may be extended. In this case, the manuscript data, sound, or visual information of the unplayed part of the program content is edited. For example, the manuscript data may be edited to adopt an expression method of making the playback time longer, or new contents may be added.

Note that in a case where the playback time of the originally planned program content is extended by the user repeatedly playing back the same program content (or rewinding, slow playback, and the like), the program content that has been scheduled to be played back may be deleted or shortened.

This allows the program provision system to finish the program content within the scheduled broadcast time even in a case where the viewer performs operations such as skip. Furthermore, the program provision system can transmit as much information as possible to the viewer within the broadcast time determined in advance.

[Functional Configuration]

The functional outline of the program provision system according to the present embodiment has been described above. Subsequently, the functional configuration of the distribution device 100 and the user terminal 200 according to the present embodiment will be described.

As described above, the distribution device 100 and the user terminal 200 can have the same functional configuration. Hereinafter, as one example, a case where the functional configurations of the distribution device 100 and the user terminal 200 are different will be described. More specifically, for the distribution device 100, the functional configuration of generating program content will be described. For the user terminal 200, the functional configuration of generating (or editing) program content by using information provided by the distribution device 100 will be described.

(Functional Configuration of Distribution Device 100)

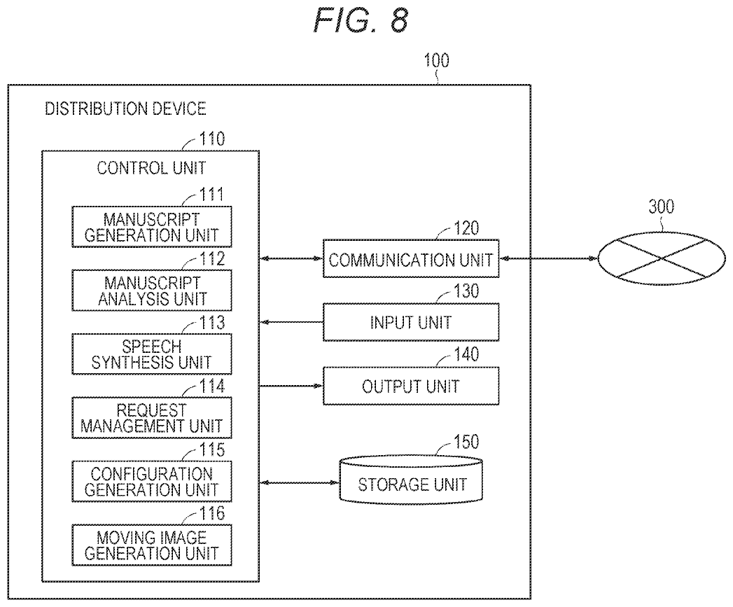

To begin with, the functional configuration of the distribution device 100 will be described with reference to FIG. 8.

As shown in FIG. 8, the distribution device 100 includes a control unit 110, a communication unit 120, an input unit 130, an output unit 140, and a storage unit 150.

(Control Unit)

The control unit 110 comprehensively controls the entire processing of the distribution device 100. For example, the control unit 110 comprehensively controls automatic generation processing of program content described later, distributes the generated program content data, and the like. As shown in FIG. 8, the control unit 110 includes a manuscript generation unit 111, a manuscript analysis unit 112, a speech synthesis unit 113, a request management unit 114, a configuration generation unit 115, and a moving image generation unit 116. Hereinafter, each functional configuration included in the control unit 110 will be described.

(Manuscript Generation Unit)

The manuscript generation unit 111 is a functional configuration that automatically generates manuscript data. For example, the manuscript generation unit 111 generates manuscript data by editing one or more sentence data input from the input unit 130 described later.

Note that when generating the manuscript data, the manuscript generation unit 111 may appropriately regenerate the manuscript data on the basis of the control by the configuration generation unit 115 described later. For example, in a case where the configuration generation unit 115 determines that the manuscript data needs to be changed on the basis of an analysis result and the like of the manuscript data after the manuscript data is generated, the manuscript generation unit 111 regenerates the manuscript data on the basis of the control by the configuration generation unit 115. The manuscript generation unit 111 provides the generated manuscript data to the manuscript analysis unit 112 and the speech synthesis unit 113.

(Manuscript Analysis Unit)

The manuscript analysis unit 112 analyzes the manuscript data generated by the manuscript generation unit 111. More specifically, the manuscript analysis unit 112 extracts information regarding contents of the manuscript data by extracting words and the like by breaking down the manuscript data. This allows the manuscript analysis unit 112 to provide the configuration generation unit 115 described later with information that is not included in various information items to be input by the user (for example, genre, type, or the like).

Note that the information to be extracted by the manuscript analysis unit 112 analyzing the manuscript data is not particularly limited. For example, the manuscript analysis unit 112 may extract a word included in the manuscript data (for example, “sea”, and the like), information associated with the word (for example, another word such as “sea bathing”, “summer”, or the like associated with “sea”, an image such as “wide”, “blue”, or the like associated with “sea”, and the like), information similar to the genre or type described above, or the like.

Furthermore, the manuscript analysis unit 112 may use information acquired from the outside when analyzing the manuscript data. For example, the manuscript analysis unit 112 may acquire information existing on the Internet and automatically determine the meaning of a word included in the manuscript data, information associated with the word, and the like. Furthermore, the manuscript analysis unit 112 may request the creator for information to be used for analysis of the manuscript data. For example, the manuscript analysis unit 112 may request the creator for information regarding contents of a word included in the manuscript data or information associated with the word. Furthermore, the manuscript analysis unit 112 may update analysis logic by learning information used for analysis of the manuscript data. This allows the manuscript analysis unit 112 to improve analysis precision as used. The manuscript analysis unit 112 provides an analysis result to the configuration generation unit 115.

(Speech Synthesis Unit)

The speech synthesis unit 113 is a functional configuration that generates voice data corresponding to the manuscript data by performing speech synthesis processing using the manuscript data generated by the manuscript generation unit 111. Note that the speech synthesis method is not particularly limited. For example, the speech synthesis unit 113 can use arbitrary speech synthesis method such as waveform connection type speech synthesis, formant synthesis, or the like. The speech synthesis unit 113 provides the generated voice data to the configuration generation unit 115.

(Request Management Unit)

The request management unit 114 is a functional configuration that receives a request from the creator of the program content and manages the request. For example, the request management unit 114 receives various pieces of setting information regarding generation of the program content. Here, the setting information received by the request management unit 114 is, but is not limited to, the genre, type, template, or the like described above. For example, the setting information may include a target person, broadcast time, data amount, screen size, resolution, sound volume, subtitle information and the like of the program content (for example, presence or absence of subtitles, language, and the like). The request management unit 114 provides information regarding the requests to the configuration generation unit 115.

(Configuration Generation Unit)

The configuration generation unit 115 is a functional configuration that generates the configuration of the entire program content. The configuration generation unit 115 has generation logic of the program content implemented by artificial intelligence technology. More specifically, the configuration generation unit 115 outputs the configuration of the program content by inputting, into the generation logic, information regarding the request of the creator provided by the request management unit 114, the analysis result provided by the manuscript analysis unit 112, voice data provided by the speech synthesis unit 113, various information items acquired from the storage unit 150, which will be described later, arbitrary information acquired from the outside (including, for example, wearable terminal worn by the viewer, and the like), and the like (information regarding date and time, season, weather, and temperature when broadcasted, region where broadcasted, sensing data of various sensors (for example, acceleration sensor, gyro sensor, barometric sensor, or the like), behavior of the viewer, situation (or environment) where the viewer is placed), and the like).

The generation logic of the program content outputs the configuration of the program content that is considered to be optimal on the basis of various information items described above by learning a large amount of program content in advance. Note that the learning method is not particularly limited, and arbitrary method used for machine learning can be used.

Here, the “configuration” generated by the configuration generation unit 115 is a concept including all the information that constitutes the program content, such as contents of the manuscript data, contents or settings of sound or visual information (for example, sound quality, sound volume, speech synthesis method, contents of BGM, contents of moving image or still image, attributes, costumes, facial expressions, or the like of the character), or a format, size, security settings, or the like of the program content data (for example, access rights and the like).

Note that the configuration of the program content generated by the configuration generation unit 115 is not restricted in any way by input various information items. For example, the configuration generation unit 115 generates the configuration of the program content on the basis of the input template, but it is not always necessary to generate the configuration according to the template. The configuration generation unit 115 may newly generate a template in which the contents of the template are partially changed, and generate the configuration on the basis of the newly generated template. With this configuration, for example, in a case where a part of the input template includes an error, the configuration generation unit 115 can generate a template including no errors on the basis of past learning results, and therefore can generate a more appropriate program content configuration.

In a case where the configuration generation unit 115 determines that it is necessary to regenerate (or edit and the like) the manuscript data, voice data, or the like on the basis of the generated configuration of the program content, by controlling the manuscript generation unit 111, the manuscript analysis unit 112, and the speech synthesis unit 113, the configuration generation unit 115 can regenerate the manuscript data, analyze the manuscript data, regenerate the voice data, and the like. Furthermore, in a case where the configuration generation unit 115 determines that it is necessary to regenerate (or edit and the like) the moving image data, the still image data, or the like on the basis of the generated configuration of the program content, the configuration generation unit 115 may regenerate (or edit and the like) the moving image data, the still image data, or the like. The configuration generation unit 115 provides the moving image generation unit 116 with the information regarding the configuration of the program content, the sound data (including voice data), the moving image data or still image data.

(Moving Image Generation Unit)

The moving image generation unit 116 is a functional configuration that automatically generates the program content data by using the information regarding the configuration of the program content, the sound data (including voice data), the moving image data or still image data provided by the configuration generation unit 115. More specifically, the moving image generation unit 116 generates the program content data by determining the format, size, security settings (for example, access rights, and the like), and the like of the program content data on the basis of the information regarding the configuration of the program content, and by integrating and packaging the sound data, the moving image data, or the still image data.

(Communication Unit)

The communication unit 120 is a functional configuration that performs communication with an external device. For example, the communication unit 120 receives various information items used by the control unit 110 to generate the program content data (for example, information used by the manuscript analysis unit 112 to analyze the manuscript data, information used by the configuration generation unit 115 to generate the configuration of the program content, or the like) from an external device (for example, WEB server on the Internet, and the like). Furthermore, in a case where the program content data generated by the control unit 110 is distributed to the user terminal 200 via an external device, the communication unit 120 transmits the program content data to the external device.

Note that the communication method of the communication unit 120 is not particularly limited. For example, any wired communication method or wireless communication method may be used for the communication method of the communication unit 120.

(Input Unit)

The input unit 130 is a functional configuration that receives input from the creator. For example, the input unit 130 includes input means such as a mouse, keyboard, touch panel, button, or the like. Various information items (for example, genre, type, template, sentence data, moving image data, still image data, or the like) are input by the creator performing various operations using these input means.

(Output Unit)

The output unit 140 is a functional configuration that outputs various information items. For example, the output unit 140 includes a display means such as a display and a voice output means such as a speaker, and displays various pieces of visual information on the display and the like on the basis of a control signal from the control unit 110, or generates various sounds by the speaker and the like.

(Storage Unit)

The storage unit 150 is a functional configuration that stores various information items. For example, the storage unit 150 stores variable information items input by the creator (for example, gene, type, template, sentence data, moving image data, still image data, and the like), variable information items generated by the distribution device 100 (manuscript data, voice data, moving image data, still image data, program content data, or the like), and the like.

Here, the configuration generation unit 115 may update the generation logic by learning the past program content data stored in the storage unit 150. Furthermore, the storage unit 150 stores programs and parameters used for various processes by the distribution device 100. Note that the information to be stored by the storage unit 150 is not limited to the above information.

(Functional Configuration of User Terminal 200)

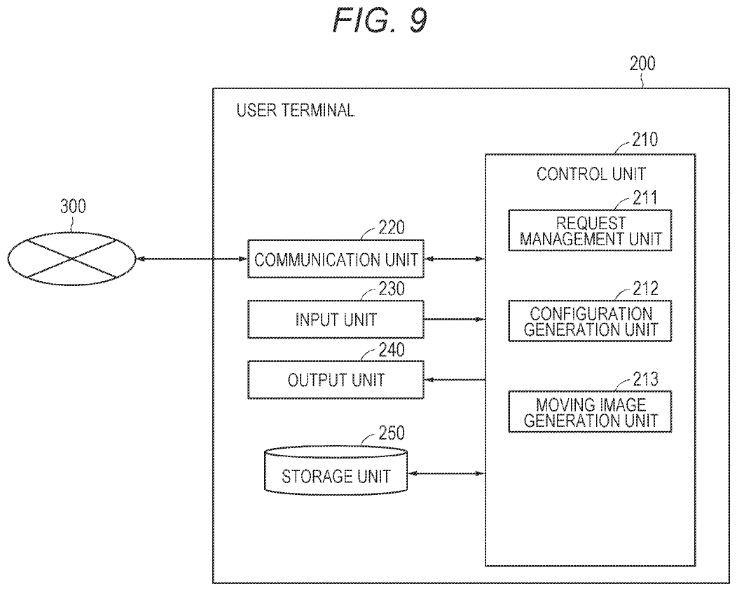

Subsequently, the functional configuration of the user terminal 200 will be described with reference to FIG. 9.

As shown in FIG. 9, the user terminal 200 includes a control unit 210, a communication unit 220, an input unit 230, an output unit 240, and a storage unit 250.

(Control Unit)

The control unit 210 comprehensively controls the entire processing of the user terminal 200. For example, the control unit 210 comprehensively controls automatic generation processing of the program content described later, plays back the generated program content data, and the like. As shown in FIG. 9, the control unit 210 includes a request management unit 211, a configuration generation unit 212, and a moving image generation unit 213. Hereinafter, each functional configuration included in the control unit 210 will be described.

(Request Management Unit)

The request management unit 211 is a functional configuration that receives a request from the viewer of the program content and manages the request. For example, the request management unit 211 receives and manages a request for skip, repeated playback, fast forward, or rewind of the program content selected by the viewer, and the program content being played back, a request for editing the program content data (for example, character attributes, contents of subtitles, contents of BGM, contents of background, and the like), information regarding various settings associated with viewing the program content (for example, display size, sound volume, speed, and the like), and the like. The request management unit 211 may manage the information regarding these requests as preference information of the viewer. Note that the information received and managed by the request management unit 211 is not limited thereto. The request management unit 211 provides the configuration generation unit 212 with the information regarding these requests.

(Configuration Generation Unit)

The configuration generation unit 212 is a functional configuration that generates the configuration of the entire program content. As described above, the user terminal 200 can generate the program content by using the request of the viewer and various information items provided by the distribution device 100. Here, an example will be described in which the manuscript data, analysis results thereof, voice data generated on the basis of the manuscript data, and the like are provided by the distribution device 100, and the user terminal 200 uses the information to generate the program content.

The configuration generation unit 212 has generation logic of the program content implemented by artificial intelligence technology in a similar manner to the configuration generation unit 115 of the distribution device 100. Then, the configuration generation unit 212 outputs the configuration of the program content by inputting, into the generation logic, various information items provided by the distribution device 100 (manuscript data, analysis results thereof, voice data generated on the basis of the manuscript data, and the like), information regarding the request of the viewer provided by the request management unit 211, various information items acquired from the storage unit 250, which will be described later, arbitrary information acquired from the outside (information such as the date and time, season, weather, and temperature when broadcasted, broadcasting region, and the like), and the like.

Note that although not shown in FIG. 9, by providing the user terminal 200 with functional configurations similar to the manuscript generation unit 111, the manuscript analysis unit 112, or the speech synthesis unit 113 of the distribution device 100, the configuration generation unit 212 may control these functional configurations as necessary to implement generation of the manuscript data, analysis of the manuscript data, generation of the voice data, and the like. The configuration generation unit 212 provides the moving image generation unit 213 with the information regarding the configuration of the program content, the sound data (including voice data), the moving image data or still image data.

(Moving Image Generation Unit)

The moving image generation unit 213 is a functional configuration that automatically generates the program content data by using the information regarding the configuration of the program content, the sound data (including voice data), the moving image data or still image data provided by the configuration generation unit 212. More specifically, the moving image generation unit 213 generates the program content data by determining the format, size, security settings (for example, access rights, and the like), and the like of the program content data on the basis of the information regarding the configuration of the program content, and by integrating and packaging the sound data, the moving image data, or the still image data.

(Communication Unit)

The communication unit 220 is a functional configuration that performs communication with an external device. For example, in a case where the user terminal 200 downloads and plays back the program content data generated by the distribution device 100, the communication unit 220 receives the program content data from an external device including the distribution device 100. Furthermore, in a case where the user terminal 200 generates the program content by using various information items provided by the distribution device 100, the communication unit 220 receives the various information items from the external device including the distribution device 100. Note that the reception of the information may be performed on the basis of an operation by the viewer, or may be performed by the communication unit 220 at predetermined timing. For example, the communication unit 220 may access the external device including the distribution device 100 at predetermined timing, and in a case where new information is generated, the communication unit 220 may receive the information.

Note that the communication method of the communication unit 220 is not particularly limited. For example, any wired communication method or wireless communication method may be used for the communication method of the communication unit 220.

(Input Unit)

The input unit 230 is a functional configuration that receives input from the viewer. For example, the input unit 230 includes an input means such as a touch panel, button, or the like. The input unit 230 performs selection of the program content to view, various settings associated with viewing the program content, and the like by the creator performing various operations by using the input means.

(Output Unit)

The output unit 240 is a functional configuration that outputs various information items. For example, the output unit 240 includes a display means such as a display and a voice output means such as a speaker, and displays various pieces of visual information on the display and the like on the basis of a control signal from the control unit 210, or generates various sounds by the speaker and the like.

(Storage Unit)

The storage unit 250 is a functional configuration that stores various information items. For example, the storage unit 250 stores the program content data and the like. Furthermore, the storage unit 250 may store the preference information of the viewer. For example, the storage unit 250 may store information regarding various settings made by the viewer in connection with viewing the program content, features of the program content viewed by the viewer, and the like as the preference information of the viewer. Furthermore, the storage unit 250 stores programs and parameters used for various processes by the user terminal 200. Note that the information to be stored by the storage unit 250 is not limited to the above information.

[Operation]

The functional configurations of the distribution device 100 and the user terminal 200 according to the present embodiment have been described above. Subsequently, operations of the distribution device 100 and the user terminal 200 will be described.

(Operation of Distribution Device)

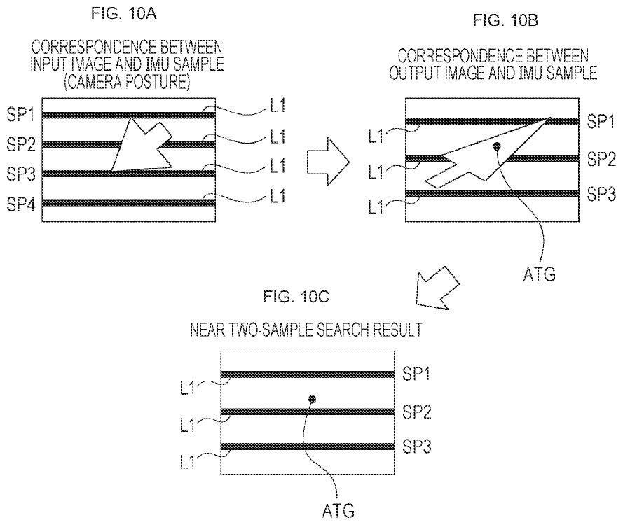

To begin with, the operation of the distribution device 100 generating program content will be described with reference to FIG. 10. In step S1000, sentence data is input into the input unit 130 by the creator of the program content. In step S1004, the manuscript generation unit 111 uses the input sentence data to generate manuscript data. In step S1008, the manuscript analysis unit 112 analyzes the generated manuscript data. Furthermore, in step S1012, the speech synthesis unit 113 generates voice data corresponding to the manuscript data by performing speech synthesis processing using the manuscript data. Note that the processing of step S1008 and the processing of step S1012 are assumed to be performed in parallel with each other, but are not limited thereto.

In step S1016, the request management unit 114 acquires information regarding a request from the creator, such as various pieces of setting information regarding the generation of the program content. The processing of step S1016 is assumed to be performed in parallel with the processing of until step S1012, but is not limited thereto.

In step S1020, the configuration generation unit 115 generates the configuration of the program content by inputting, into the generation logic, the information regarding the request of the creator provided by the request management unit 114, analysis results provided by the manuscript analysis unit 112, the voice data provided by the speech synthesis unit 113, and the like.

In a case where it is necessary to regenerate the manuscript data on the basis of the generated configuration of the program content (step S1024/yes), the process proceeds to step S1004, and the manuscript generation unit 111 regenerates the manuscript data. In a case where it is not necessary to regenerate the manuscript data (step S1024/no), in step S1028, the moving image generation unit 116 generates the program content data by using the information regarding the configuration of the program content, the sound data (including voice data), the moving image data or still image data, whereby the process finishes.

(Operation of User Terminal)

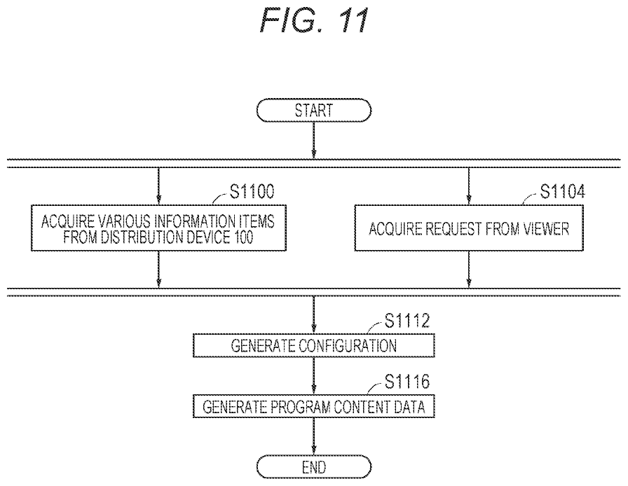

Subsequently, with reference to FIG. 11, the operation of the user terminal 200 generating the program content by using various information items provided by the distribution device 100 will be described.

In step S1100, the configuration generation unit 212 acquires various information items to be used to generate the program content provided by the distribution device 100 via the communication unit 220 (manuscript data, analysis results thereof, voice data generated on the basis of the manuscript data, and the like).

In step S1104, the request management unit 211 acquires information regarding a request from the viewer, such as various pieces of setting information regarding the generation of the program content. The processing of step S1104 is assumed to be performed in parallel with the processing of step S1100, but is not limited thereto.

In step S1112, the configuration generation unit 212 generates the configuration of the program content by inputting, into the generation logic, various information items provided by the distribution device 100 (manuscript data, analysis results thereof, voice data generated on the basis of the manuscript data, and the like), the information regarding the request of the viewer provided by the request management unit 211, and the like.

In step S1116, the moving image generation unit 213 generates the program content data by using the information regarding the configuration of the program content and the like, whereby the process finishes.

Note that although not described in FIG. 11, in a case where the manuscript data, voice data, or the like needs to be regenerated, the user terminal 200 may request the distribution device 100 to regenerate each data as appropriate, and the user terminal 200 may regenerate each data by providing a functional configuration similar to the manuscript generation unit 111, the manuscript analysis unit 112, or the speech synthesis unit 113 of the distribution device 100.

[Hardware Configuration]

The operations of the distribution device 100 and the user terminal 200 according to the present embodiment have been described above. Subsequently, hardware configurations of the distribution device 100 and the user terminal 200 will be described.

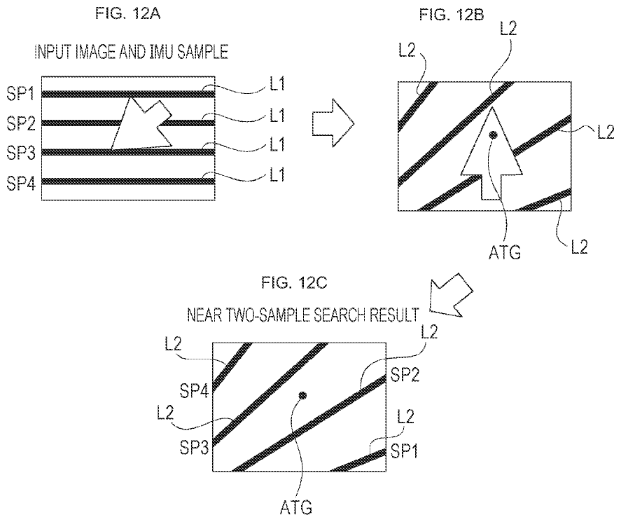

Various types of processing described above are implemented by collaboration between software and hardware described below. FIG. 12 is a diagram showing the hardware configuration of an information processing device 900 that embodies the distribution device 100 and the user terminal 200.

The information processing device 900 includes a central processing unit (CPU) 901, a read only memory (ROM) 902, a random access memory (RAM) 903, a host bus 904, a bridge 905, an external bus 906, an interface 907, an input device 908, an output device 909, a storage device (HDD) 910, a drive 911, and a communication device 912.

The CPU 901 functions as an arithmetic processing device and a control device, and controls the overall operation in the information processing device 900 in accordance with various programs. Furthermore, the CPU 901 may be a microprocessor. The ROM 902 stores programs, arithmetic parameters, and the like used by the CPU 901. The RAM 903 temporarily stores programs used in the execution of the CPU 901 and parameters and the like that appropriately change in the execution. These are mutually coupled by the host bus 904 including a CPU bus and the like. By the collaboration of the CPU 901, the ROM 902 and the RAM 903, each function of the control unit 110 of the distribution device 100 and the control unit 210 of the user terminal 200 is implemented.

The host bus 904 is coupled to the external bus 906 such as a peripheral component interconnect/interface (PCI) bus via the bridge 905. Note that the host bus 904, the bridge 905, and the external bus 906 do not necessarily have separated configurations, and these functions may be implemented in one bus.

The input device 908 includes an input means for a user to input information, such as a mouse, keyboard, touch panel, button, microphone, switch, lever, and the like, an input control circuit that generates an input signal on the basis of input by the user and outputs the input signal to the CPU 901, and the like. By operating the input device 908, the user who uses the information processing device 900 can input various data to each device or give instructions to perform processing operations. Each function of the input unit 130 of the distribution device 100 and the input unit 230 of the user terminal 200 is implemented by the input device 908.

The output device 909 includes, for example, a display device such as a cathode ray tube (CRT) display device, a liquid crystal display (LCD) device, an organic light emitting diode (OLED) device, a lamp, and the like. Moreover, the output device 909 includes a voice output device such as a speaker or a headphone. The output device 909 outputs, for example, played content. Specifically, the display device displays various information items such as played video data as text or images. Meanwhile, the voice output device converts the played voice data and the like into voice and outputs the voice. Each function of the output unit 140 of the distribution device 100 and the output unit 240 of the user terminal 200 is implemented by the output device 909.

The storage device 910 is a device for storing data. The storage device 910 may include a storage medium, a recording device that records data in the storage medium, a reading device that reads data from the storage medium, an erasing device that erases data recorded in the storage medium, and the like. The storage device 910 includes, for example, a hard disk drive (HDD). This storage device 910 drives the hard disk and stores programs executed by the CPU 901 or various data. Each function of the storage unit 150 of the distribution device 100 and the storage unit 250 of the user terminal 200 is implemented by the storage device 910.

The drive 911 is a reader-writer for a storage medium, and is built in or externally attached to the information processing device 900. The drive 911 reads information recorded on a mounted removable storage medium 913 such as a magnetic disk, optical disk, magneto-optical disk, or semiconductor memory, and outputs the information to the RAM 903. Furthermore, the drive 911 can also write information in the removable storage medium 913.

The communication device 912 is, for example, a communication interface including a communicating device for connecting to a communication network 914 and the like. Each function of the communication unit 120 of the distribution device 100 and the communication unit 220 of the user terminal 200 is implemented by the communication device 912.

[Conclusion]

As described above, the program provision system according to the present disclosure can implement the function of automatically generating manuscript data to be broadcasted, the function of automatically generating sound or visual information of the program content, the function of adapting the sound or visual information to transmitted information, playback date and time, or the like, the function of automatically adding the operation of the character, the function of requesting the information used for automatically generating the program content, the function of automatically generating the manuscript according to the playback situation of the program content, the function of inserting the information on another contents into the program content being played back, the function of providing unplayed program content to the user, the function of editing the program content associated with skip and the like, and the like. This allows the program provision system according to the present disclosure to reduce generation costs of the program content while maintaining high quality of the program content including sound or visual information.

### Second Embodiment

Next, a second embodiment will be described. Note that items described in the first embodiment described above (for example, configuration of the program provision system, configuration and function of the distribution device 100, configuration and function of the user terminal 200, and the like) can also be applied to the second embodiment unless otherwise specified.

[Outline]

To begin with, an outline of the second embodiment will be described. In the second embodiment, for example, material data including sentence data including a control character is transmitted from the user terminal 200 to the distribution device 100. The material data is transmitted, for example, using an electronic mail system. The distribution device 100 that has received mail data analyzes material data included in the mail data in a case where address information on the mail data is address information set in advance, and automatically generates program content data based on the material data. The second embodiment will be described in detail below.

[About Setting Example]

To begin with, various settings are made for automatically generating program content data. Such settings are made, for example, by the distribution device 100. A setter is, for example, a service provider who provides the program content data. Note that the program content data can also be automatically generated by the user terminal 200. In such a case, the settings described below are made by the user terminal 200, and the setter becomes an owner of the user terminal 200 and the like. Furthermore, the user terminal 200 may make various settings, setting contents may be transmitted to the distribution device 100, and the distribution device 100 may automatically generate the program content data according to the transmitted setting contents.

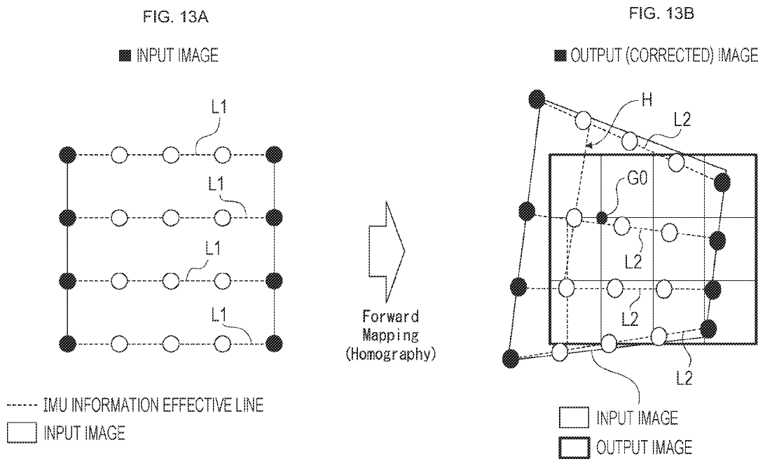

FIG. 13 shows one example of a setting screen for making various settings for automatically generating the program content data (setting screen 400). The setting screen 400 is displayed, for example, on an output unit 140 (specifically, display) of the distribution device 100. One example of setting items on the setting screen 400 and contents that can be set in the setting items will be described below.

A setting item 401 is an item for making a setting regarding the aspect ratio of the display that displays the program content. In the illustrated example, “horizontal (16: 9)” is set. A setting item 402 is an item for making a setting regarding whether or not to play back a sound effect. In a case where a check box in the setting item 402 is checked, the sound effect will be played back, and in a case where not checked, the sound effect will not be played back. Note that the sound effect according to the present embodiment is preset data. A setting item 403 is an item for making a setting regarding whether or not to display subtitles. In a case where the check box in the setting item 403 is checked, the subtitles corresponding to the voice uttered by a character are displayed, and in a case where not checked, the subtitles are not displayed.

A setting item 404 is an item for making a setting regarding a character's type and a character's costume. In the illustrated example, “AA” (for example, a female character) is set as the character's type, and “summer clothes” is set as the character's costume. A setting item 405 is an item for making a setting regarding a background theme (background color). In the illustrated example, “blue” is set as the background theme. A setting item 406 is an item for making a setting regarding a background mode (for example, background change pattern). In the illustrated example, “normal” is set as the background mode. Note that as the background mode, it is possible to select a plurality of patterns different from the predetermined background mode “normal.”

A setting item 407 is an item for making a setting regarding a moving image output format. As will be described in detail later, the program content data automatically generated by the distribution device 100 is output to the storage device and the like of the distribution device 100. The file format for output can be set by using the setting item 407. In the illustrated example, “mp4” is set as the moving image output format. It is possible to select another moving image output format (avi and the like) by operating the setting item 407.

Setting items 408 to 410 are items for making settings regarding a mail linkage function of the distribution device 100. The mail linkage function is a function of reflecting mail contents on automatic generation of the program content (details will be described later). Specific contents of each item will be described.

The setting item 408 is an item for making a setting regarding the mail address. In the illustrated example, one mail address is shown in the setting item 408, but a plurality of mail addresses may be set. In a case where the distribution device 100 receives mail data having the mail address set in the setting item 408, the distribution device 100 automatically generates the program content data. In a case where the distribution device 100 receives mail data having another mail address, the distribution device 100 does not automatically generate the program content data. In the illustrated example, “AAA@.co.jp” is set as the mail address.

The setting item 409 is an item for making a setting regarding a cycle for receiving (or sending and receiving) the mail data (polling cycle). In the illustrated example, “10 minutes” is set as the check cycle, but arbitrary time can be set as the check cycle. The setting item 410 is a storage device that writes the program content data automatically generated by the distribution device 100, and more specifically, the setting item 410 is an item for making a setting regarding an address of a shared folder. The automatically generated program content data is stored in the shared folder set in the setting item 410. Note that the shared folder set in the setting item 410 is accessible to the predetermined user terminal 200, and the predetermined user terminal 200 can view the program content corresponding to the program content data stored in the shared folder.

A setting item 411 is an item for making a setting regarding intonation of text to speech (TTS). Here, it is possible to include a user dictionary defined by a user regarding TTS intonation. Note that in the illustrated example, the user dictionary regarding TTS intonation is set as “None”.

In the setting screen 400, a save icon 412 is selected in a case where the setting using the setting screen 400 is completed. A back icon 413 is selected when display contents are changed from the setting screen 400 to another screen.

Note that the display for making each of the settings described above is displayed, for example, on the right side of the setting screen 400. On the left side of the setting screen 400, for example, a confirmation screen 415 is displayed. The confirmation screen 415 is a screen on which each setting contents can be confirmed. For example, a character and the like are displayed on the confirmation screen 415. When a setting regarding the type and clothes of the character is made, the type and clothes of the character on the confirmation screen 415 will change. This is similar in the background theme and the like. By displaying such a confirmation screen 415, the setter can confirm specific display according to the setting contents.

[About Mail Contents Example]

Next, one example of sentence data included in message information created by the user terminal 200 will be described. In the present embodiment, as one example of the message information, mail data is used for description and an example in which sentence data is described in a mail will be described. Furthermore, as one example of account information, a mail address for identifying individual mail data is used for description. Note that the mail data described below may be created by the distribution device 100 and transmitted to the distribution device 100 itself.

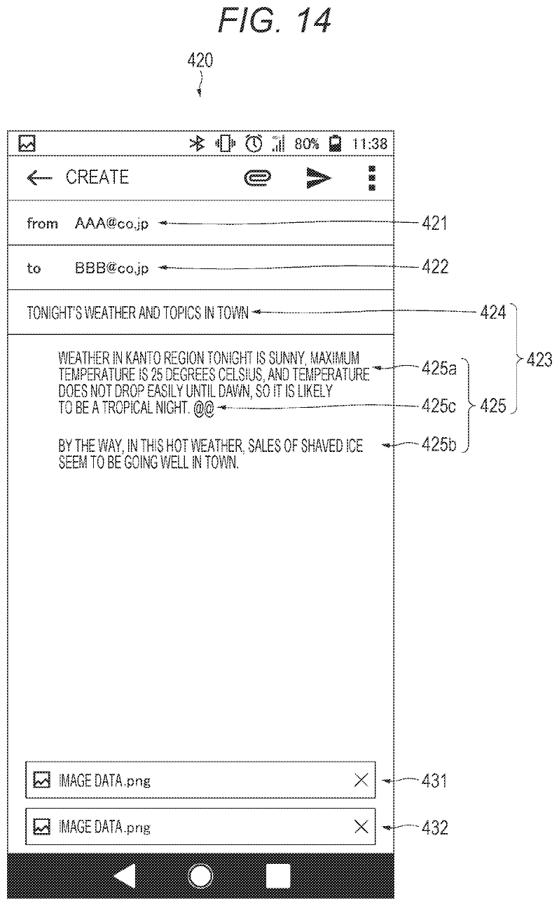

FIG. 14 shows an example of a mail screen (mail screen 420) created by the user terminal 200. The mail screen 420 is displayed on an output unit 240 (specifically, display) of the user terminal 200. Input of the mail is made by using, for example, an input unit 230.

A transmission address (mail address of the user terminal 200 of the mail creator) 421 is displayed on the upper row side of the mail screen 420. In the illustrated example, the transmission address 421 is, for example, “AAA@co.jp”, and the mail address set in the item regarding the mail linkage function described above is assumed.

A reception address 422, which is the destination of the mail, is displayed on the under side of the transmission address 421. In the illustrated example, “BBB@co.jp” is displayed as the reception address 422. The reception address 422 “BBB@co.jp” is, for example, the mail address possessed by the distribution device 100.

A sentence (message) 423 input by the user is displayed on the under side of the reception address 422. In the illustrated example, the sentence 423 includes a subject 424 and a body 425. Note that the subject 424 may be a blank column. The body 425 includes, for example, a first body 425a, a second body 425b, and a control character 425c input between the first body 425a and the second body 425b.

The first body 425a is, for example, a sentence “It will be sunny tonight in the Kanto region, the maximum temperature will be 25 degrees Celsius, and the temperature will not drop easily until dawn, so it will be a tropical night.”

The second body 425b is a sentence with contents different from contents of the first body 425a, for example, “By the way, it seems that the sales of shaved ice are going well in the city in this hot weather.”

Note that in the illustrated example, the first and second bodies 425a and 425b are each one sentence, but are not limited to this example, and arbitrary number of sentences can be used. Furthermore, in the illustrated example, one blank line is inserted after the control character 425c, but the one line is not always necessary. The first body 425a, the control character 425c, and the second body 425b may be continuously input.

The control character 425c is, for example, two characters “@@” and is input at the end of the first body 425a. The control character 425c may be a character string different from “@@”, but from the viewpoint of convenience of input, it is preferable to use a character that is relatively often used with the number of characters relatively small (for example, between 1 character and 16 characters inclusive). The control character 425c may be a character, a symbol, a number, or a combination thereof. In the program content automatically generated by the distribution device 100, predetermined control is performed at the timing corresponding to the position where the control character 425c is specified. In the present embodiment, an image is switched at the timing corresponding to the position where the control character 425c is specified. The control contents corresponding to the control character 425c is programmed in advance in the control unit 110. Note that, for example, by using the setting screen 400, control contents corresponding to the control character 425c may be selected from among a plurality of control contents.

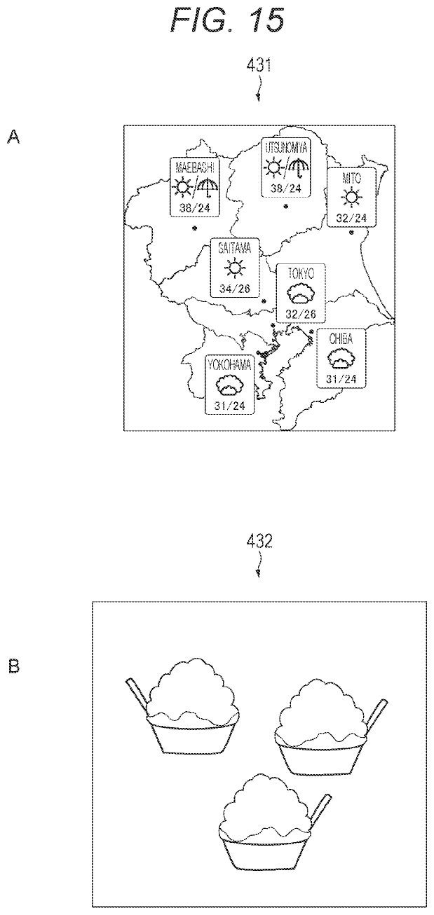

As shown in FIG. 14, for example, two image data (image data 431 and image data 432) are attached to the mail data according to the present embodiment. That is, the material data according to the present embodiment includes sentence data including the control character 425c (sentence data corresponding to the first and second bodies 425a and 425b) and the image data. FIG. 15 shows one example of the attached images. FIG. 15A shows one example of the image data 431. The image data 431 is an image showing the general weather condition of the Kanto region, the maximum/minimum temperature of each prefecture in the Kanto region, and the like, and is an image corresponding to the contents of the first body 425a. The image data 432 is an image showing a plurality of shaved ices, and is an image corresponding to the contents of the second body 425b.

After creating the mail with the contents illustrated in FIG. 14, the user of the user terminal 200 transmits the mail to the distribution device 100. Since mail is a tool for general purpose use, the user terminal 200 can easily create the mail illustrated in FIG. 14.

[Operation]

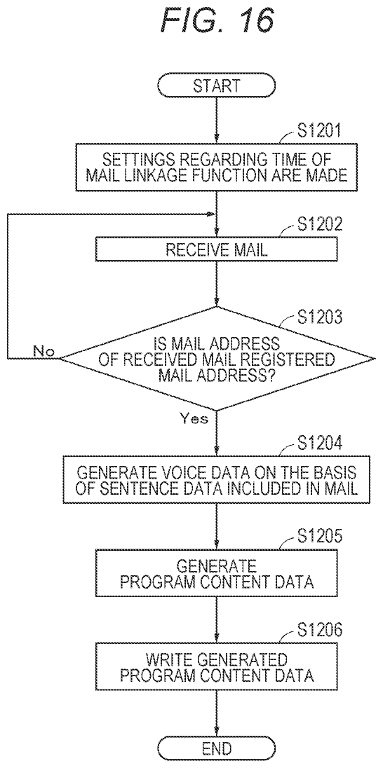

Upon receiving the mail, the distribution device 100 analyzes the material data included in the mail and automatically generates the program content data. Hereinafter, processing of automatically generating the program content data by the distribution device 100 will be described with reference to the flowchart shown in FIG. 16.

In step S1201, a setting regarding the mail linkage function and the like is made using the setting screen 400 described above. Then, the process proceeds to step S1202.

In step S1202, the distribution device 100 receives the mail transmitted from the user terminal 200 via the communication unit 120. Then, the process proceeds to step S1203.

In step S1203, the control unit 110 of the distribution device 100 determines whether or not the mail address of the received mail is the mail address registered on the setting screen 400 (more specifically, setting item 408 regarding the mail linkage function in the setting screen 400). Here, in a case where the mail address of the received mail is different from the registered mail address (negative determination in step S1203), the process returns to step S1202. In a case where the mail address of the received mail agrees with the registered mail address (positive determination in step S1203), the process returns to step S1204.

In step S1204, the control unit 110 of the distribution device 100, specifically, the speech synthesis unit 113 generates voice data corresponding to the sentence data of the body included in the mail data. At this time, the speech synthesis unit 113 generates the voice data corresponding to the sentence data excluding the control character 425c (character “@@”). Then, the process proceeds to step S1205.

In step S1205, the program content data is generated. The program content data is automatically generated by the moving image generation unit 116 on the basis of the configuration of the program content generated by the configuration generation unit 115. The configuration generation unit 115 generates the configuration of the program content data on the basis of the contents set in the setting screen 400. Specifically, the configuration generation unit 115 generates the configuration such that preset images and sound data such as the character and character's costume, background setting, sound effect, and the like set in the setting screen 400 will be reflected in the program content data. Moreover, the configuration generation unit 115 generates the configuration in which the image corresponding to the image data attached to the mail data is switched at the position where the control character 425c is specified, and outputs the configuration as information regarding the configuration of the program content. The configuration generation unit 115 outputs, to the moving image generation unit 116, the information regarding the configuration of the program content, the voice data corresponding to the sentence data of the mail, the image data attached to the mail, preset data that are set to perform output such as display in the setting screen 400, and the like.

Then, the moving image generation unit 116 automatically generates the program content data on the basis of the information and data supplied from the configuration generation unit 115. In this way, the moving image generation unit 116 acquires material data including sentence data including a control character, analyzes the material data, performs output based on the sentence data, and automatically generates program content data on which control based on the control character is reflected. Note that the output based on the sentence data is assumed to be voice output in this example, but may be feedback such as display or vibration to the viewer of the program content. Then, the process proceeds to step S1206.

In step S1206, the moving image generation unit 116 writes and stores the automatically generated program content data, for example, in the storage unit 150. Here, the storage unit 150 in which the program content data is stored is a storage device that can be connected to a network such as, for example, a network attached storage (NAS). A transmitter who has transmitted the mail to the distribution device 100 can confirm what kind of program content is created by the mail created by the transmitter by connecting to the storage device and playing back the stored program content data. Note that the storage device in which the automatically created program content data is stored is not limited to the storage unit 150, and may be a storage device included in a device on the cloud.

[Specific Example of Program Content]

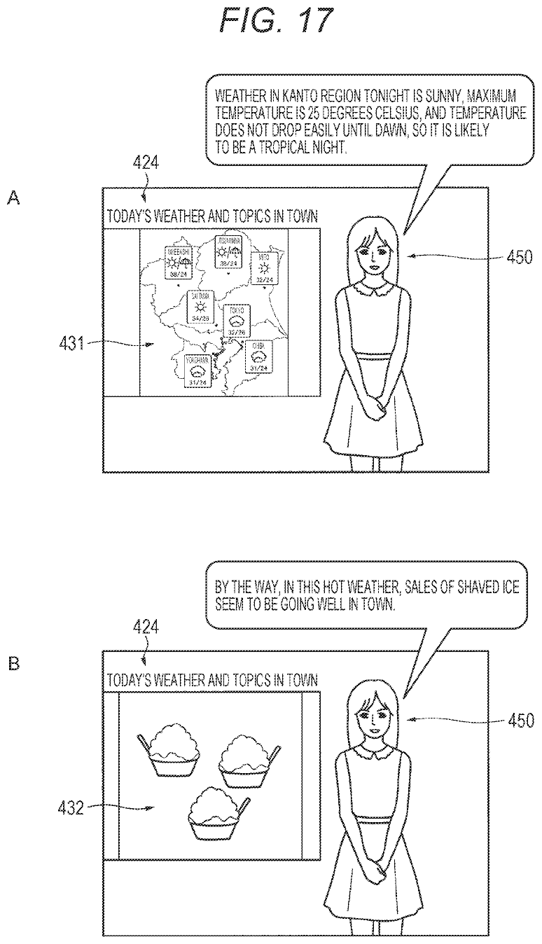

Specific examples of automatically generated program content will be described with reference to FIGS. 17A and 17B. An instruction to play back the automatically generated program content is provided, and the program content is played back. As shown in FIG. 17A, a character 450 is displayed on the right side of the screen. The type, costume, and the like of the character 450 are as set in the setting screen 400. This is similar in the background and the like. Furthermore, an image corresponding to the image data 431 attached to the mail data (weather image) is displayed on the left side of the screen. On the upper left side of the screen, contents described in the subject of the mail is displayed as a title of the program content. In this way, in the present embodiment, sentence data corresponding to the subject of the mail is displayed, and such setting contents are described in the program executed by the moving image generation unit 116. Note that in a case where there is no mail subject, nothing may be displayed.

When the image shown in FIG. 17A is displayed, for example, an opening theme is played back. The playback of the opening theme is performed, for example, by playing back preset voice data in a case where it is set in the setting screen 400 that there is a sound effect. When the playback of the opening theme is finished, the character 450 talks. Contents of the talk is contents of the first body 425a described in the mail body. The character 450 is displayed to move the mouth while talking. As described in the first embodiment, the facial expression of the character 450 may change or the intonation of the voice may change.

When the playback of the voice corresponding to the first body 425a is finished, contents talked by the character 450 transitions to contents of the second body 425b. As described above, the control character 425c indicating image switching is input between the first body 425a and the second body 425b of the mail. Therefore, the control based on the control character 425c is reflected on the program content. Specifically, when the playback of the sound corresponding to the first body 425a is finished, the displayed image changes to an image corresponding to the image data 432 (shaved ice image) as shown in FIG. 17B. Then, the character 450 talks contents corresponding to the second body 425b. As described above, the program content on which the contents described in the mail (including the control contents) is reflected is played back.

[Conclusion]

In the second embodiment, by simply including the control character in the sentence data, the program content data on which the control based on the control character is reflected can be automatically generated.

Furthermore, by using a general-purpose mail, even a user without special skills can easily create sentence data including the control character. Furthermore, there is no need to create a special tool for creating program content, and anyone can be involved in creating program content.

Furthermore, the user can obtain the program content data on which the control the user desires is reflected by simply transmitting a mail to the device that automatically generates the program content data.

Furthermore, the automatically generated program content data is output to the NAS and the like to make the program content data accessible, thereby allowing the user to view the program content on which the control desired by the user is reflected. If the user who has viewed the program content is dissatisfied with results thereof (for example, image switching timing), the user can easily edit and modify the contents of the program content by simply editing the mail contents again and transmitting the mail to the distribution device.

Furthermore, if there is a voice, image, and the like the user wants to use in the program content data, it is only required to attach the voice, image, and the like to the mail. Moreover, by simply inputting the control character, it is possible to specify the timing for playing back the voice or image attached to the mail.

### Modification of Second Embodiment

Contents of the second embodiment can be modified as follows, for example.

In the above description, the control contents corresponding to the control character are image switching, but the control contents are not limited to this example. The control contents corresponding to the control character can be appropriately set. For example, the control contents corresponding to the control character may cause a character in the program content to perform a predetermined operation. In this case, the program content is automatically generated such that the character performs the predetermined operation at timing corresponding to the position where the control character is specified in the mail sentence. The control contents corresponding to the control character may be defined by using the setting screen 400 and the like. Furthermore, the control contents corresponding to the control character may be defined in the transmitted mail.

In the above description, the control character is described as “@@”, but the control character is not limited to this example, and other character or number may be used. However, it is preferable that the number of characters (for example, 16 characters or less) and the character type allow simple input and are easy for the user to remember. Note that what character is easy to use and remember as the control character depends on the user. Therefore, the control character itself may be definable by the user.

In the above description, the image data is attached to the mail, but the image data may not be attached and the material data may be only sentence data. Note that different program content may be automatically generated depending on the presence or absence of attached data such as image data. For example, in the above description, in order to display the image corresponding to the image data attached to the mail, the program content with the character displayed on the right side of the screen is automatically generated. However, in a case where, for example, no image data is attached to the mail, it is not necessary to display the character on the right side. Therefore, in a case where, for example, no image data is attached to the mail, for example, the program content may be automatically generated such that the standing position of the character is in front. Furthermore, depending on the presence or absence of attached image data, the control unit of the distribution device may change the control contents corresponding to the control character.

In the above description, the automatically generated program content data is stored in the storage unit. Access to the stored program content data may be restricted. For example, restriction may be set such that only the mail transmitter or a specific user can access the stored program content data. Furthermore, the automatically generated program content data may be disclosed to an unspecified number of users. In this case, restriction on a reading period of the program content and the like may be set. The program content may be disclosed for pay. Furthermore, feedback from the user who reads the program content (for example, impressions, evaluations, and the like) may be given. The created program content data may be automatically distributed to a specific user terminal.

In a case where the above-described processing is performed, it is assumed that insertion of the control character may be forgotten. Therefore, processing may be performed to switch the image appropriately even in a case where there is no control character. For example, in a case where there is a term indicating that the control unit switches topics (for example, “from here”) but no control character is inserted before the term, processing of switching the image may be performed regardless of the presence or absence of the control character. Furthermore, in a case where image contents are analyzed, the analysis result is matched with the sentence data, and the matching degree is equal to or higher than a certain level, even in a case where there is no control character, the processing of switching the image may be performed.

The automatically generated program content data may be automatically distributed at a predetermined time. The predetermined time can also be set using the setting screen 400 and the like.

The sentence data included in the mail described above may be input by a plurality of users. For example, it is possible to create one program content data on which predetermined control is reflected by sharing among a plurality of users.

In the above description, the mail data transmitted using the electronic mail system as one example of message information has been described, and an example in which the sentence data (message) is described in the mail has been described, but this is not restrictive. The message information may be the short message service (SMS), multimedia messaging service (MMS), chat, comment, bulletin board provided via a network, and the like. The sentence data may be input thereto. For example, a bulletin board on a network that allows writing on the distribution device side may be prepared. The user may log in to the bulletin board and the like and input sentence data including the control character in the bulletin board. The distribution device automatically generates the program content data according to the sentence data and the like input to the bulletin board. Furthermore, in the above description, the mail address is used as one example of account information, but the account information may be any information as long as the information can identify the transmitter, such as a telephone number, password, user ID (Identification), and the like.

The processing performed by the distribution device described above may be performed by the user terminal. Furthermore, the processing described above can also be implemented by a method or a program. By downloading and installing the program, the user can automatically generate the program content data with the terminal owned by the user.

For example, each step shown in each flowchart described above does not necessarily have to be processed on a time-series basis according to the order described as the flowchart. That is, each step may be processed in order different from the order described as the flowchart or may be processed in parallel.

Furthermore, the functional configuration of the distribution device or the user terminal may be changed as appropriate. For example, part of the functional configuration of the distribution device or the user terminal may be provided in an external device as appropriate. Furthermore, the control unit of the distribution device may implement part of the functions of the communication unit, the input unit, and the output unit. Furthermore, the control unit of the user terminal may implement part of the functions of the communication unit, the input unit, and the output unit.

Note that the present disclosure can also have the following configurations.

(1)

An information processing device including

a control unit configured to acquire material data including sentence data including a control character, analyze the material data, perform output based on the sentence data, and automatically generate program content data on which control based on the control character is reflected.

(2)

The information processing device according to (1), in which

in a case where the control unit receives message information including predetermined account information, the control unit analyzes the material data included in the message information.

(3)

The information processing device according to (2), in which

the message information includes first sentence data corresponding to a subject and second sentence data corresponding to a body, and

the control unit automatically generates program content data in which at least the first sentence data is displayed and voice output corresponding to the second sentence data is performed.

(4)

The information processing device according to (3), in which

in a case where the control character is included in the second sentence data, the control unit automatically generates program content data in which voice output corresponding to the second sentence data excluding the control character is performed.

(5)

The information processing device according to any one of (2) to (4), in which

the control unit automatically generates program content data in which an image is switched at timing corresponding to a position where the control character is specified.

(6)

The information processing device according to (5), in which

the image includes a plurality of images attached to the message information.

(7)

The information processing device according to any one of (2) to (6), in which

the control unit automatically generates program content data in which a character performs a predetermined operation at timing corresponding to a position where the control character is specified.

(8)

The information processing device according to any one of (2) to (7), in which

the control unit automatically generates different program content data depending on presence or absence of attached data of the message information.

(9)

The information processing device according to any one of (1) to (8), in which

the control unit stores the automatically generated program content data in a storage device.

(10)

The information processing device according to (9), further including

the storage device.

(11)

The information processing device according to (9), in which

the program content data stored in the storage device allows access from a user terminal.

(12)

The information processing device according to (11), in which

restriction on the access from the user terminal is set.

(13)

The information processing device according to (12), in which

the restriction includes at least one of restriction on a reader of the program content data and restriction on a reading period of the program content data.

(14)

The information processing device according to any one of (1) to (13), in which

the control unit automatically generates the program content data including preset content data.

(15)

The information processing device according to any one of (1) to (14), in which

the control character includes a character, a symbol, and a number of between 1 character and 16 characters inclusive, or a combination of the character, the symbol, and the number.

(16)

An information processing system including:

a communication unit configured to receive message information including sentence data including a control character, the message information being transmitted from an arbitrary terminal; and

a control unit configured to analyze the sentence data, perform output based on the sentence data, and automatically generate program content data on which control based on the control character is reflected in a case where account information of the received message information is predetermined account information.

(17)

An information processing method including, by a control unit:

acquiring material data including sentence data including a control character, analyzing the material data, performing output based on the sentence data, and automatically generating program content data on which control based on the control character is reflected.

(18)

A program for causing a computer to execute an information processing method including, by a control unit:

acquiring material data including sentence data including a control character, analyzing the material data, performing output based on the sentence data, and automatically generating program content data on which control based on the control character is reflected.
100 Distribution device
110 Control unit
111 Manuscript generation unit
112 Manuscript analysis unit
113 Speech synthesis unit
114 Request management unit
115 Configuration generation unit
116 Moving image generation unit
120 Communication unit
130 Input unit
140 Output unit
150 Storage unit
200 User terminal
210 Control unit
211 Request management unit
212 Configuration generation unit
213 Moving image generation unit
220 Communication unit
230 Input unit
240 Output unit
250 Storage unit
300 Network

1. An information processing device comprising
a control unit configured to acquire material data including sentence data including a control character, analyze the material data, perform output based on the sentence data, and automatically generate program content data on which control based on the control character is reflected.

2. The information processing device according to claim 1, wherein
in a case where the control unit receives message information including predetermined account information, the control unit analyzes the material data included in the message information.

3. The information processing device according to claim 2, wherein
the message information includes first sentence data corresponding to a subject and second sentence data corresponding to a body, and
the control unit automatically generates program content data in which at least the first sentence data is displayed and voice output corresponding to the second sentence data is performed.

4. The information processing device according to claim 3, wherein
in a case where the control character is included in the second sentence data, the control unit automatically generates program content data in which voice output corresponding to the second sentence data excluding the control character is performed.

5. The information processing device according to claim 2, wherein
the control unit automatically generates program content data in which an image is switched at timing corresponding to a position where the control character is specified.

6. The information processing device according to claim 5, wherein
the image includes a plurality of images attached to the message information.

7. The information processing device according to claim 2, wherein
the control unit automatically generates program content data in which a character performs a predetermined operation at timing corresponding to a position where the control character is specified.

8. The information processing device according to claim 2, wherein
the control unit automatically generates different program content data depending on presence or absence of attached data of the message information.

9. The information processing device according to claim 1, wherein
the control unit stores the automatically generated program content data in a storage device.

10. The information processing device according to claim 9, further comprising
the storage device.

11. The information processing device according to claim 9, wherein
the program content data stored in the storage device allows access from a user terminal.

12. The information processing device according to claim 11, wherein
restriction on the access from the user terminal is set.

13. The information processing device according to claim 12, wherein
the restriction includes at least one of restriction on a reader of the program content data and restriction on a reading period of the program content data.

14. The information processing device according to claim 1, wherein
the control unit automatically generates the program content data including preset content data.

15. The information processing device according to claim 1, wherein
the control character includes a character, a symbol, and a number of between 1 character and 16 characters inclusive, or a combination of the character, the symbol, and the number.

16. An information processing system comprising:
a communication unit configured to receive message information including sentence data including a control character, the message information being transmitted from an arbitrary terminal; and
a control unit configured to analyze the sentence data, perform output based on the sentence data, and automatically generate program content data on which control based on the control character is reflected in a case where account information of the received message information is predetermined account information.

17. An information processing method comprising, by a control unit:
acquiring material data including sentence data including a control character, analyzing the material data, performing output based on the sentence data, and automatically generating program content data on which control based on the control character is reflected.

18. A program for causing a computer to execute an information processing method comprising, by a control unit:
acquiring material data including sentence data including a control character, analyzing the material data, performing output based on the sentence data, and automatically generating program content data on which control based on the control character is reflected.
